(19) United States
(12) Patent Application Publication
(10) Pub. No.: US 2011/0264507 A1
(43) Pub. Date: Oct. 27, 2011

(54) FACILITATING KEYWORD EXTRACTION FOR ADVERTISEMENT SELECTION

(75) Inventors: JI ZHOU, BEIJING (CN); JING CHEN, BEIJING (CN); YI ZHANG, REDMOND, WA (US); WEIBIN ZHU, BEIJING (CN)

(73) Assignee: MICROSOFT CORPORATION, REDMOND, WA (US)

(21) Appl. No.: 12/768,341

(22) Filed: Apr. 27, 2010

(51) Int. Cl. G06Q 30/00; G06F 15/18; G06N 5/02; G06F 17/30

(52) U.S. Cl. 705/14.42; 707/749; 706/12; 707/E17.044; 706/46

(57) ABSTRACT

Systems, methods, and computer storage media having computer-executable instructions embodied thereon that facilitating keyword extraction for advertisement selection. A set of performance indicators that indicate performance of a keyword in association with one or more advertisements is referenced. A determination is made as to whether the keyword is a noise keyword that is relevant to web content and results in a low click rate or a low impression cost. The set of performance indicators and the determination of whether the keyword is a noise keyword are utilized to identify a keyword type of the keyword, wherein a keyword type can be a positive keyword or a negative keyword.

### BACKGROUND

Advertisements are commonly displayed in association with web content, such as a set of search results or a webpage. Selecting an advertisement for display in association with web content is generally based on keywords within the web content available at the time of advertisement delivery. In operation, a score is oftentimes calculated for keywords in association with web content. For instance, a higher score might represent a keyword that is more relevant or related to the web content, or subject matter thereof, while a lower score might represent a keyword that is less relevant or related to the web content, or subject matter thereof. By way of example only, a website pertaining to the sport of basketball might contain keywords “score” and “car.” In such a case, the keyword “score” is very relevant to the subject matter of the website and, as such, receives a higher score (e.g., a 0.9 on a scale from zero to one). Conversely, the keyword “car” is less relevant to the subject matter of the website and thereby receives a lower score (e.g., a 0.1 on a scale from zero to one). Keywords in association with web content, such as keywords extracted via a keyword extractor, and scores in association therewith can be utilized by an advertisement delivery engine to select contextual advertisements for display to one or more users. Generally, keywords with a higher score receive more advertisement impressions and thereby result in more advertisement revenue.

To score keywords, a keyword model including coefficients that correspond with keyword features is generated and utilized to score keywords. A keyword feature refers to a feature in association with a keyword, such as the length of a keyword. Training such coefficients using human labeled data (i.e., human labelers indicating an extent of relevancy or whether a keyword is relevant or not) can produce inefficient and ineffective results. In this regard, obtaining human labeled data can be time consuming and, thereby, expensive. Further, the quality of the resulting coefficients and/or model associated therewith can be compromised as humans have varying opinions regarding relevancy of keywords to a webpage.

Upon establishing a keyword model, the keyword model is used to score keywords associated with a webpage and, thereafter, the more relevant keyword(s) are used to select an advertisement(s) for display. In some cases, however, a keyword identified as a relevant keyword may result in a low click rate (e.g., a click-through-rate (CTR)) and/or low impression cost (e.g., effective cost per mille (eCPM)). For example, a keyword having a low commercial value or a keyword that is too general to attract users might be identified as a relevant keyword but result in a low click rate and/or low impression cost. Such keywords that are identified as relevant yet result in a low click rate and/or impression cost are referred to herein as noise keywords. Extracting noise keywords that are, thereafter, used to select an advertisement for display can negatively impact a click-through-rate and revenue associated with an advertisement.

### SUMMARY

Embodiments of the present invention relate to systems, methods, and computer-readable media for, among other things, facilitating keyword extraction for advertisement selection. In this regard, embodiments of the present invention facilitate keyword scoring and/or noise filtering to enhance selection of advertisements for display. Keyword extraction is utilized to extract one or more keywords in association with web content, such as a webpage. A relevance score indicating a relevance of a keyword to the web content is calculated for keywords using a keyword model. Such a keyword model is automatically trained using click rates, impression costs, and/or noise indicators. The extracted keywords and corresponding relevance scores are utilized to select an advertisement for display. In some cases, a noise filter is also utilized in association with the extracted keywords and corresponding relevance scores to select an advertisement for display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a block diagram of an exemplary computer system for use in implementing embodiments of the present invention;

FIG. 4 illustrates example score vectors within a coordinate system, in accordance with embodiments of the present invention;

FIG. 5 is a flow diagram showing a first method for facilitating keyword extraction for advertisement selection, in accordance with an embodiment of the present invention; and

FIG. 6 is a flow diagram showing a second method for facilitating keyword extraction for advertisement selection, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that facilitate keyword extraction for advertisement selection. In this regard, embodiments of the present invention facilitate keyword scoring and/or noise filtering to enhance selection of advertisements for display. Keyword extraction is utilized to extract one or more keywords in association with web content, such as a webpage. A relevance score indicating a relevance of a keyword to the web content is generally calculated for keywords using a keyword model. In embodiments, a keyword model is trained using click rates, impression costs, and/or noise indicators. Such extracted keywords and corresponding relevance scores are utilized to select an advertisement for display to one or more users. In some cases, a noise filter is also utilized in association with the extracted keywords and corresponding relevance scores to select an advertisement for display.

Accordingly, in one aspect, the present invention is directed to one or more computer storage media having computer-executable instructions embodied thereon, that when executed, cause a computing device to perform a method for facilitating keyword extraction for advertisement selection. The method includes referencing a set of performance indicators that indicate performance of a keyword in association with an advertisement. A determination is made as to whether the keyword is a noise keyword that is relevant to web content and results in a low click rate or a low impression cost. The set of performance indicators and the determination of whether the keyword is the noise keyword are utilized to identify a keyword type of the keyword, wherein a keyword type comprises a positive keyword or a negative keyword.

In another aspect, the present invention is directed to a method for facilitating keyword extraction for advertisement selection. The method includes extracting a keyword from web content. A click-through-rate and an effective cost per mille are used to determine that the keyword is a noise keyword. The keyword is designated as a noise keyword, and such a designation is used to generate a keyword model that is used to score other keywords.

In yet another aspect, the present invention is directed to one or more computer storage media having computer-executable instructions embodied thereon, that when executed, cause a computing device to perform a method for facilitating keyword extraction for advertisement selection. The method includes extracting a keyword from a first webpage in association with a uniform resource locator. A set of one or more performance indicators in association with the keyword is identified. The set of performance indicators is used to determine whether the keyword is a noise keyword. A keyword type of the keyword is identified based on at least a portion of the set of performance indicators and the determination of whether the keyword is the noise keyword. A keyword type can be a positive keyword, negative keyword, or profitable keyword. The keyword type is used to generate a training dataset. A keyword model is generated in accordance with the training dataset. The keyword model is used to score keywords subsequently extracted from web content based on relevance to the web content or subject matter thereof.

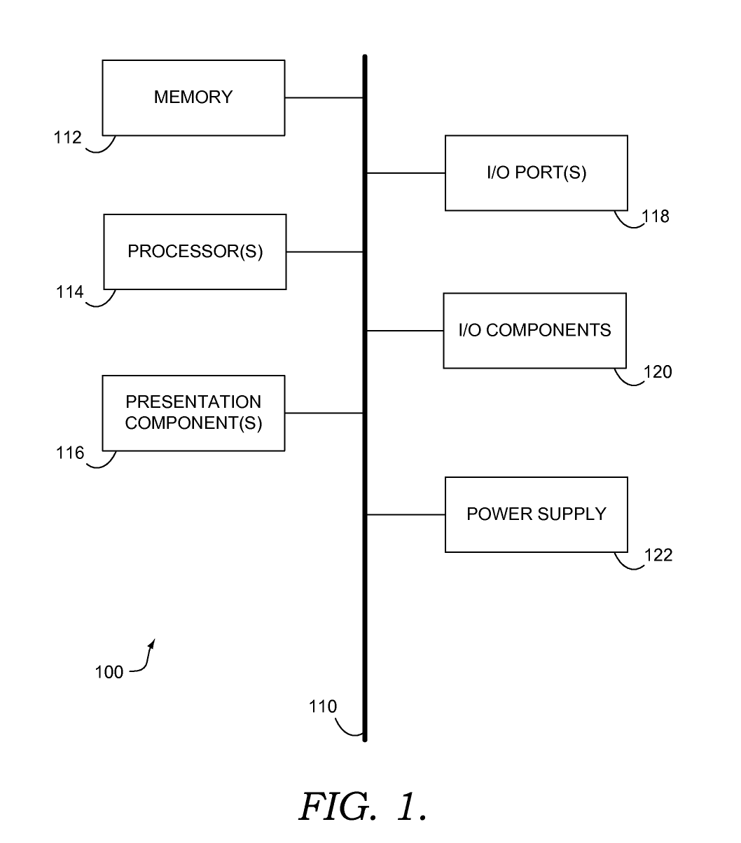

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

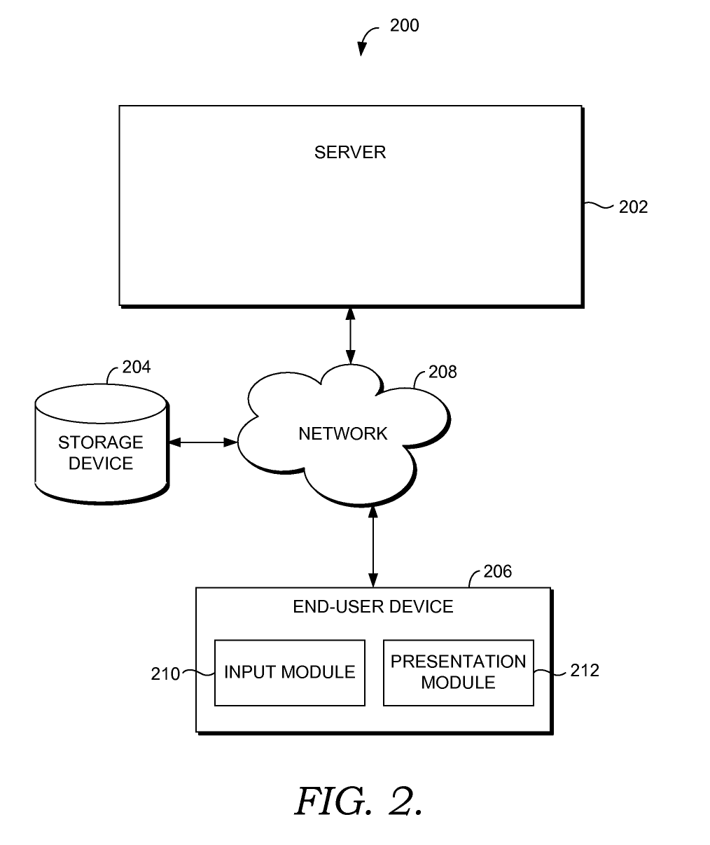

With reference to FIG. 2, a block diagram is illustrated that shows an exemplary computing system architecture 200 configured for use in implementing embodiments of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, and an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with keyword extraction, relevance scores, keyword scores, and advertisement selection. In various embodiments, such information may include, without limitation, keywords, relevance scores, keyword scores, keyword features, feature coefficients, noise keywords, advertisements, webpage content, keyword types, training datasets, keyword models, performance indicators, and/or the like. In embodiments, the storage device 204 is configured to be searchable for one or more of the items stored in association therewith. It will be understood and appreciated by those of ordinary skill in the art that the information stored in association with the storage device 204 may be configurable and may include any information relevant to one or more keywords, keyword scores, relevance scores, keyword features, feature coefficients, noise keywords, advertisements, webpage content, keyword types, training datasets, keyword models, performance indicators, and/or the like. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via a network, e.g., network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single unit, one skilled in the art will appreciate that the server 202 is scalable. For example, the server 202 may in actuality include a plurality of servers in communication with one another. Moreover, the storage device 204 may be included within the server 202 or end-user device 206 as a computer-storage medium. The single unit depictions are meant for clarity, not to limit the scope of embodiments in any form.

As shown in FIG. 2, the end-user device 206 includes a user input module 210 and a presentation module 212. In some embodiments, one or both of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for receiving input. Such input might include, for example, user search queries. Typically, input is input via a user interface (not shown) associated with the end-user device 206, or the like. Upon receiving input, the presentation module 212 of the end-user device 206 is configured for presenting advertisements, for example, in association with search results or a webpage. Embodiments are not intended to be limited to visual display but rather may also include audio presentation, combined audio/video presentation, and the like.

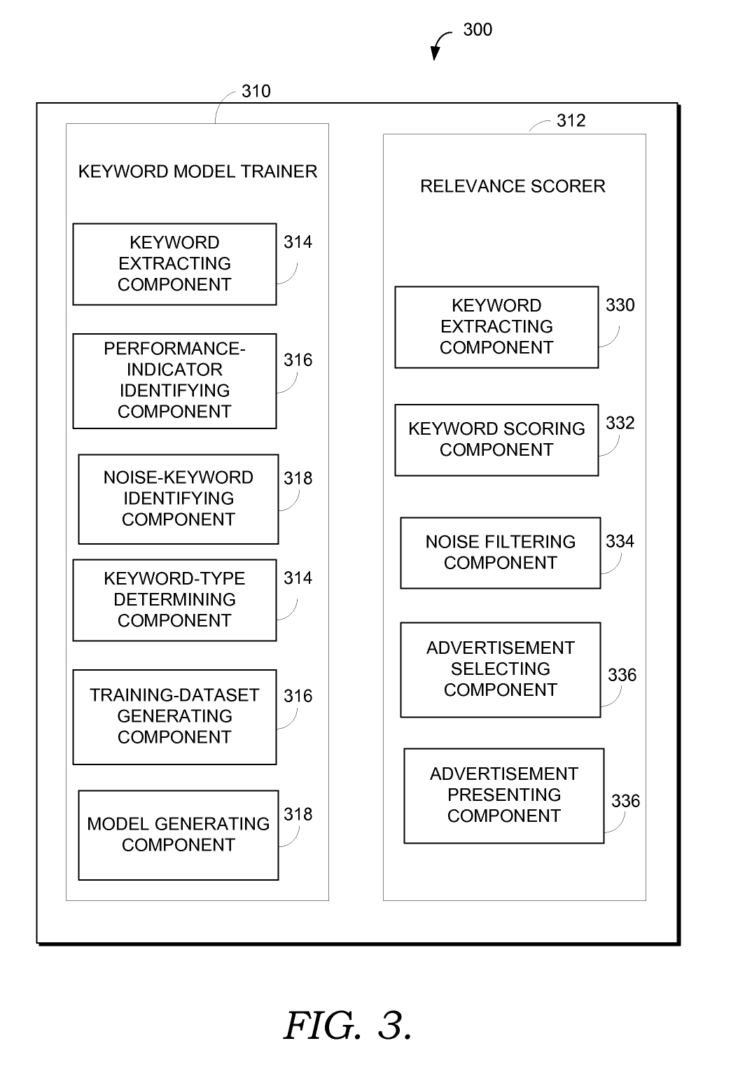

FIG. 3 illustrates an exemplary computing system 300 for facilitating keyword extraction for advertisement selection. As shown in FIG. 3, an exemplary computing system 300 includes a keyword model trainer 310 and a relevance scorer 312. The keyword model trainer 310 is configured to train a keyword model(s), as described more fully below. In embodiments, the keyword model trainer 310 includes a keyword extracting component 314, a performance-indicator identifying component 316, a noise-keyword identifying component 318, a keyword-type determining component 320, a training-dataset generating component 322, and a model generating component 324. The relevance scorer 312 is configured to score keywords and select advertisements for display. In embodiments, the keyword scorer includes a keyword extracting component 330, a relevance scoring component 332, a noise filtering component 334, an advertisement selecting component 336, and an advertisement presenting component 338.

In some embodiments, one or more of the illustrated components/modules may be implemented as stand-alone applications. In other embodiments, one or more of the illustrated components/modules may be integrated directly into the operating system of the server 202, a cluster of servers (not shown) and/or the end-user device 206. It will be understood by those of ordinary skill in the art that the components/modules illustrated in FIG. 3 are exemplary in nature and in number and should not be construed as limiting. Any number of components/modules may be employed to achieve the desired functionality within the scope of embodiments hereof. Further, components/modules may be located on any number of servers or computing devices. By way of example only, the advertisement selecting component 336 and the advertisement presenting component 338 might reside on a server, cluster of servers, or computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The keyword model trainer 310 is configured to train a keyword model(s). A keyword model refers to any model (e.g., an equation) that can be used to score keywords in accordance with relevance to particular web content, such as a webpage, or subject matter thereof. In one embodiment, the keyword model trainer 310 corresponds with a keyword extractor that extracts keywords, such as keywords related to a topic of the webpage, generates relevance scores, and outputs the keywords and relevance scores, for example, to an advertisement delivery engine. In this regard, the keyword model trainer 310, or a portion thereof, is part of or is in communication with a keyword extractor, for example, that resides on one or more servers or computing devices. In some embodiments, keyword model trainer 310 performs one or more functions as an offline process. Alternatively or additionally, keyword model trainer 310 performs one or more functions as an online process, such as, for example, removing noise keywords, selecting advertisements for display, and presenting advertisements for display.

The keyword extracting component 314 is configured to extract keywords in association with web content (e.g., a webpage). The keyword extracting component 314 can use any method to extract keywords from web content, such as a webpage. By way of example only, the keyword extracting component 314 might extract each word within particular web content, words related to or pertaining to subject matter of the web content, particular types of words (e.g., nouns, verbs, etc.), words randomly selected, a word sampling including positive and negative keyword types, or the like. As can be appreciated, the web content (e.g., website, webpage) from which keywords are extracted can be referenced and/or selected in any number of ways. By way of example, and not limitation, web content can be randomly selected, selected based on an algorithm, selected in accordance with a predetermined order, or the like.

The performance indicator identifying component 316 is configured to identify performance indicators. A performance indicator, as used herein, refers to any data that indicates performance of a keyword in association with a set of one or more advertisements. In embodiments, performance of a keyword is limited to a particular webpage or Uniform Resource Locator (URL). That is, in cases that a keyword has been used to select an advertisement or is associated with a selected advertisement, a performance indicator indicates the performance of the keyword in association with an advertisement(s) (e.g., advertisement(s) corresponding with a keyword is displayed, viewed, selected, etc.). By way of example only, a performance indicator of a keyword might be an impression count, a click count, a revenue, a click rate (e.g., a CTR), an impression cost (e.g., eCPM), or the like, in association with a keyword.

In embodiments, performance indicators are indicative of performance of a keyword in association with an advertisement(s) during a period of time (e.g., a performance time). As such, a performance indicator indicates an impression count, a click count, a revenue, a click rate, an impression cost, etc., that occurs or exists within a particular time period. A predetermined or dynamically determined performance time used for identifying performance indicators can facilitate accurate results. A performance time that is too short can result in keywords having minimal impressions and thereby effect a determination of keyword type. On the other hand, a performance time that is too long can provide more opportunity for a change of web page content, which decreases the quality of training a dataset. By way of example only, performance indicators can be measured over a two-week time period. Such a two-week time period allows keywords to obtain enough impressions while minimizing opportunity for a change of webpage content.

In some cases, performance indicators are identified via a keyword extractor log, such as an online data log. A keyword extractor log logs data regarding keywords, such as impression count, click count and revenue. In this regard, performance indicators can be identified by receiving, retrieving, recognizing, or referencing data from an online keyword extractor log that records impressions, clicks, and revenue, and the like.

In other cases, performance indicators are identified by performing calculations. For example, click rates and impression costs might be identified upon performing calculations. As can be appreciated, click rates and impression costs can be calculated using data within a keyword extractor log (e.g., impression counts, click counts, revenue, etc.). Accordingly, in some embodiments, performance indicators can be used to calculate other performance indicators.

A click-through-rate can be calculated using a click count in association with a keyword of a URL and an impression count in association with a keyword of a URL. A click count refers to the number of instances that an advertisement was clicked or selected. An impression count refers to the number of instances that an advertisement was displayed and/or viewed. In embodiments, a click-through-rate equals the number of instances an advertisement(s) associated with a keyword of a URL was clicked divided by the number of instances the advertisement(s) associated with the keyword of the URL was delivered. As such, a click-through-rate can be calculated using the following algorithm:

CTR_{<kw,url>}=Click_{<kw,url>}/Impression_{<kw,url>} Equation 1

An impression cost (e.g., an eCPM, CPM, CPI) can be calculated using revenue of a keyword of a URL and impressions in association with a keyword of a URL. In embodiments, an impression cost (e.g., eCPM) equals 1,000 times the revenue of an advertisement(s) associated with a keyword of a URL divided by the number of instances the advertisement(s) associated with the keyword of the URL was delivered. Accordingly, an effective cost per mille impressions (eCPM) can be calculated using the following algorithm:

eCPM_{<kw,url>}=1000*Revenue_{<kw,url>}/Impression_{<kw,url>} Equation 2

The noise-keyword identifying component 318 is configured to identify noise keywords. A noise keyword refers to a keyword that is identified as relevant to web content, or subject matter thereof, but that in association with advertisement(s) results in a low click rate (e.g., a click-through-rate (CTR)) and/or low impression cost (e.g., effective cost per mille (eCPM) for an advertiser). For example, a keyword having a low commercial value or a keyword that is too general to attract users might be identified as a relevant keyword but in association with an advertisement(s) results in a low click rate and/or impression cost.

In one embodiment, noise-keyword identifying component 318 identifies noise keywords for a domain using one or more performance indicators. As such, an average click rate, an average cost impression, and/or an average keyword impression are calculated using performance indicators. In embodiments, an average click rate equals an average of click-through-rates in association with a keyword for each URL in a domain. Accordingly, an average click rate can be calculated using the following algorithm:

CTR_{domain}=Σ_{∀kw,∀urlεdomain}^{Click}_{<kw,url>}/Σ_{∀kw,∀urlεdomain}^{Impression}_{<kw,url>} Equation 3

An average cost impression, in one embodiment, equals an average of cost impressions in association with a keyword for each URL in a domain. According, an average cost impression can be calculated using the following algorithm:

eCPM_{domain}=1000*Σ_{∀kw,∀urlεdomain}^{Revenue}_{<kw,url>}/Σ_{∀kw,∀urlεdomain}^{Impression}_{<kw,url>} Equation 4

In embodiments, an average keyword impression equals a total number of impressions in association with a keyword for a URL/domain divided by a total keyword count (i.e., the number of different keywords in a domain/URL or the number of different keywords extracted from a domain/URL). As such, an average keyword impression can be calculated using the following algorithm:

I̅m̅p̅r̅e̅s̅s̅i̅o̅n̅=Σ_{∀<kw,url>}^{Impression}_{<kw,url>}/TotalKeywordCount Equation 5

By way of example only, assume a total of three keywords are extracted. Further assume that the first keyword corresponds with ten impressions, the second keyword corresponds with twenty impressions, and the third keyword corresponds with thirty impressions for a total of sixty impressions. In such a case, the average keyword impression is twenty (i.e., 60 total impressions divided by 3 different keywords).

Each keyword that has an impression larger than 1000 times of the average keyword impression is selected. In this regard, essentially keywords that are frequently associated with advertisements are selected. In one embodiment, an impression of a keyword is the sum of impressions of a particular keyword in every URL. For instance, an impression of a keyword is the sum of impressions of a specific keyword presented in each URL within a particular domain. In such an embodiment, an impression can be calculated using the following algorithm:

$${Impression}_{kw} = {\sum }_{∀ url} {Impression}_{< kw , url >} \qquad Equation 6$$

Accordingly, it follows that a set of selected keywords is in accordance with the following algorithm:

LargeImpKeywordSet={kw|Impression_{kw}>1000* I̅m̅p̅r̅e̅s̅s̅i̅o̅n̅} Equation 7

The set of selected keywords is utilized to identify noise keywords. For each keyword in the keyword set, and for each domain, noise keywords are identified. In embodiments, a keyword is identified or designated as a noise keyword when a large impression number exists in association with a low performance. In this regard, a keyword is identified as a noise keyword if:

CTR_{<kw,domain>}<x*CTR_{domain}, and Equation 8

eCPM_{<kw,domain>}<x*eCPM_{domain}, Equation 9

wherein, the CTR and eCPM of the keyword “kw” in a domain can be calculated using the following algorithm:

CTR_{<kw,domain>}=Σ_{∀urlεdomain}^{Click}_{<kw,url>}/Σ_{∀urlεdomain}^{Impression}_{<kw,url>} Equation 10

eCPM_{<kw,domain>}=1000*Σ_{∀urlεdomain}^{Revenue}_{<kw,url>}/Σ_{∀urlεdomain}^{Impression}_{<kw,url>} Equation 11

While “x” can equal any number, in one embodiment, “x” is set to 0.2. Although illustrated herein as identifying noise keywords for each domain, as can be appreciated, additionally or alternatively, noise keywords can be identified for each URL.

The keyword type determining component 320 is configured to determine keyword types in association with keywords. In embodiments, a keyword type might be a positive keyword, a negative keyword, or a profitable keyword. A positive keyword refers to a keyword that is deemed or inferred to be relevant to the webpage or subject matter thereof and has a high commercial value. A negative keyword refers to a keyword that is deemed or inferred to be irrelevant to the webpage or subject matter thereof or has a low commercial value. A profitable keyword refers to a keyword that is deemed or inferred to be profitable. Positive keywords, negative keywords, and/or profitable keywords can be deemed or inferred as such in accordance with a threshold(s), as described more fully below. In this regard, a keyword can be identified as positive, negative, and/or profitable upon a performance indicator(s), or a calculation in association therewith, exceeding or being less than a corresponding threshold.

In one embodiment, a click count, a click rate (e.g., a CTR), and an impression count are utilized to identify a positive keyword. Accordingly, in some cases, a keyword is identified as a positive keyword when a CTR associated with a keyword is significantly larger than a predetermined percent (e.g., exceeds a percent positive threshold, such as 0.02%) and has a sufficient number of clicks (e.g., exceeds a click positive threshold). By way of example only, in cases that a click count of a keyword in association with a URL is greater than a positive threshold, a statistic t-test result of a CTR value of a keyword in association with the URL is greater than 1.96, and the keyword is not identified as a noise keyword in the domain of the URL, the keyword is determined to be a positive keyword. A proper value for a click positive threshold might be 20 for a two week period. In some cases, a keyword is identified as a positive keyword if:

1) Keyword is not identified as a noise keyword in the domain of ‘URL’,

$$\begin{matrix} 2 ) {Click}_{< kw , url >} \geq ClickPosThreshold , and & Equation 12 \\ 3 ) {t}_{test ( < kw , url . )} \geq 1.96 , wherein & Equation 12 \\ {t}_{test ( < kw , url > )} = ( C T {R}_{< kw , url >} - 0.029 \% ) / \sqrt{\frac{C T {R}_{< kw , url >} * ( 1 - C T {R}_{< kw , url >} )}{{Impression}_{< kw , url >}}} & Equation 14\end{matrix}$$

In one embodiment, a click count and an impression count are utilized to identify a negative keyword. Accordingly, in some cases, a keyword is identified as a negative keyword when a CTR associated with a keyword is less than a predetermined percent (e.g., less than a click negative threshold, such as 0.02%) and has a sufficient number of impressions (e.g., exceeds an impression threshold). By way of example only, in cases that an impression count of a keyword in association with a URL is greater than an impression threshold and the click count of the keyword is less than a click negative threshold, the keyword is determined to be a negative keyword. Alternatively or additionally, a keyword might be designated as a negative keyword if the keyword is identified as a noise keyword in the domain of the URL. A proper value for an impression threshold might be 10,000 for a two-week period, and a proper value for a click negative threshold might be 2 for a two-week period. In some cases, a keyword is identified as a negative keyword if:

1) Impression_{<kw,url>}≧ImpThreshold, and Equation 15

Click_{<kw,url>}≧ClickNegThreshold, or Equation 16

2) The keyword is identified as a domain keyword in the domain of ‘URL’

In one embodiment, an impression cost (e.g., a eCPM) is utilized to identify a profitable keyword. Accordingly, in some cases, a keyword is identified as a profitable keyword when a normalized impression cost for a keyword of a particular URL is greater than an impression cost threshold and the keyword is not identified as a noise keyword in the domain of the URL. A proper value for an impression cost threshold might be 0.9 for a two-week period. The norm function can be used to normalize an impression cost to range from zero to one. In this regard, a keyword is identified as a profitable keyword if:

1) norm(eCPM_{<kw,url>})>eCPMNormThreshold, or Equation 17

2) The keyword is identified as a domain keyword in the domain of ‘URL’

To attain and/or maintain a quality training dataset, URLs and/or domains might also be analyzed. In such a case, a domain type and/or a URL type might be determined. A domain type provides an indication of the strength of the domain. A URL type provides an indication of the strength of the URL. By way of example only, a URL is designated as a positive URL in cases in which the URL contributes at least one positive keyword or negative keyword. That is, a URL having at least one keyword extracted therefrom that is identified as a positive or negative keyword is designated as a positive URL. A domain is designated as a positive domain in cases in which the domain contains at least five positive URLs. Alternative or additionally, a domain black list can be used to remove any domains not suitable for contextual advertisements (e.g., pages containing only images or videos). In this regard, a domain is a positive domain if it contains at least five positive pages and is not listed in the black list. In some embodiments, any keywords extracted from a URL and/or a domain that is not considered a positive URL and/or positive domain might be excluded from a training dataset. As can be appreciated, any manner of analyzing URLs and/or domains can be utilized to attain and/or maintain a quality training dataset.

The training-dataset generating component 322 is configured to generate a training dataset, or a portion thereof. In embodiments, a training dataset is generated using the extracted keywords and corresponding identified keyword types. A training dataset might include, for example, a keyword score(s) and a keyword feature(s) for each keyword of the training dataset. A keyword feature refers to any feature characterizing or describing a keyword. By way of example and not limitation, a keyword feature might be a length of a keyword, a keyword frequency (i.e., a number of times a phrase or term is queried in a search engine), a visual style score (i.e., a score that indicates the visual style, such as bold, font, etc. of the keyword), TFIDF, etc. In embodiments, features are defined by a keyword extractor system. Such a system will provide a feature dump service to dump features of a given keyword and URL pair. As can be appreciated, in some cases, a keyword feature is a number or a value.

A keyword score of a keyword refers to a probability (e.g., weight) that the keyword is positive (i.e., relevant to the webpage content and has high commercial value). The probability (e.g., weight) of a keyword being negative (i.e., not relevant or has a low commercial value) is one minus the keyword score. In one embodiment, the following scores are assigned to each keyword type:

| | Positive Category | Negative Category |
|---|---|---|
| Keyword Type | Score | Score |
| Positive Sample Keyword | 1.0 | 0.0 |
| Negative Sample Keyword | 0.0 | 1.0 |
| Profitable Sample Keyword | 0.9 | 0.1 |

For instance, assume that a keyword is determined to be a positive keyword type. In such a case, the keyword has a positive category score of 1.0 and a negative category score of 0.0. In cases that a negative keyword is identified, the keyword has a positive category score of 0.0 and a negative category score of 1.0. In cases that a profitable keyword is identified, the keyword has a positive category score of 0.9 and a negative category score of 0.1. In such an embodiment, using two category scores (e.g., with a sum equal to one) can assist with calculating a coefficient for each keyword feature.

By way of example only, assume that a keyword is associated with three keyword features, FA, FB, and FC. Further assume that the keyword is identified as a positive keyword and has a positive category score of 1.0 and a negative category score of 0.0. In such a case, for this particular keyword, the training dataset includes the keyword features FA, FB, and FC as well as a positive category score of 1.0 and a negative category score of 0.0.

The model generating component 324 is configured to generate a keyword model. In embodiments, a keyword model is trained using the training dataset. In such a case, a logistic regression algorithm can be used to calculate a coefficient for keyword features of a keyword. By way of example only, assume a keyword (KW) is associated with three keyword features, FA, FB, and FC. Further assume that F_{A} represents the value of feature FA of keyword KW, F_{B} represents the value of feature FB of keyword KW, and FC represents the value of feature F_{C} of keyword KW. A positive category score for the keyword KW is represented as Sp, and a negative category score for the keyword KW is represented as S_{N}. Each keyword feature has two coefficients (i.e., a coefficient in association with a positive category score and a coefficient in association with a negative category score). Continuing with this example, C_{PA} is used to represent the positive coefficient of feature FA, and C_{NA} represents the negative coefficient of feature FA, etc. Accordingly, for keyword KW, there are two formulas (i.e., one formula in association with the positive category score Sp and one formula in association with the negative category score S_{N}.

LF(C_{PA}*F_{A}+C_{PB}*F_{B}+C_{PC}*F_{C}+C_{P})=S_{P} Equation 18

LF(C_{NA}*F_{A}+C_{NB}*F_{B}+C_{NC}*F_{C}*C_{N})=S_{N} Equation 19

wherein,

LF(x)=1/(1+ê(−x))and Equation 20

C_{P} and C_{N} represent two more coefficients that do not relate to a single feature.

In such an example, the logistic regression process identifies or determines a value for C_{PA}, C_{PB}, C_{PC}, C_{P}, C_{NA}, C_{NB}, C_{NC}, C_{N}. As such, the logistic regression process intends to minimize any gap between the LF result and S_{P} and S_{N}. Such coefficient values can be identified by substituting the corresponding feature values and/or the positive and negative category scores for the keyword (KW). The coefficients can be stored as a keyword model, or a portion thereof.

In some embodiments, upon an initial generation of a keyword model, a verification of the keyword model is performed. The verification checks the model trained by the training dataset to verify quality of the model. Such verification may be performed by calculating the cosine distance between the calculated category scores and labeled category scores. In embodiments, a verification is performed using the following equations:

$$\begin{matrix}\overline{CosineDistance} = \frac{{\sum }_{sample ∈ TrainingSet} {CosineDistance}_{sample}}{\vert TrainingSet \vert} & Equation 21 \\ {CosineDistance}_{sample} = \frac{{{CatWeight}_{labeled}}^{} \cdot {{CatWeitht}_{calc}}^{}}{\vert {{CatWeight}_{labeled}}^{} \vert \vert {{CatWeight}_{calc}}^{} \vert} & Equation 22 \\ {CatWeight}_{calc} = \frac{( {e}^{{CatLogWeight}_{1}} {e}^{{CatLogWeight}_{2}} )}{{e}^{{CatLogWeight}_{1}} + {e}^{{CatLogWeight}_{2}}} & Equation 23 \\ {CalLogWeight}^{} = {FeaWeight}_{1 + n} \times {Model}_{n + z} & Equation 24\end{matrix}$$

In verifying a keyword model, the result might be a float number within the range of zero to one. Generally, a higher result indicates a better training dataset and keyword model. Usually, the result should be larger than 0.707106781 (cos(π/4)) to indicate a strong training dataset and/or keyword model.

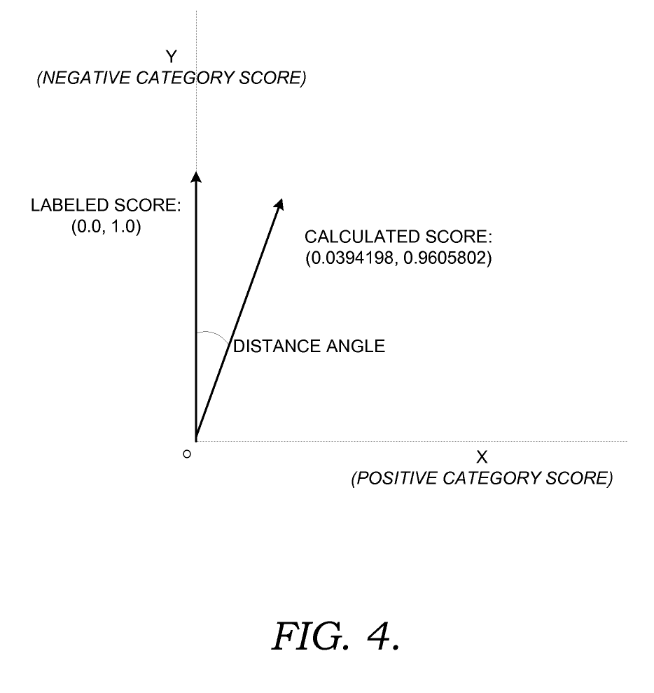

By way of example only, in a Cartesian coordinate system, assume that an x-axis represents a positive keyword score, and a y-axis represents a negative keyword score. For a particular keyword, using the corresponding positive and negative score, a point in the coordinate system can be drawn. From the origin of coordinate to the keyword point is a vector (i.e., a keyword score vector). Assume that the keyword “test” is labeled as a negative keyword. In such a case, the labeled score in the training data is (0.0, 1.0) (x=positive category score=0.0, and y=negative category score=1.0). Further assume that the calculated score is (0.0394198, 1−0.0394198)=(0.0394198, 0.9605802). FIG. 4 illustrates the score vectors drawn on the coordinate system. As is illustrated in FIG. 4, the cosine of the angle between the two vectors is the distance between labeled score and calculated score. The overall distance is the average value of all keywords' cosine distance.

In some cases, generating a keyword model can be an iterative process. In this regard, as datasets can be generated periodically (e.g., every two weeks), a new training dataset can be combined or merged with previously generated training datasets and/or human labeled datasets. In such a case, a new or updated keyword model can be generated using the merged training dataset.

The relevance scorer 312 is configured to score keywords and select advertisements. In one embodiment, the relevance scorer 312 corresponds with a keyword extractor that extracts keywords, such as keywords related to a topic of the webpage, generates a relevance score, and outputs the keywords and relevance scores, for example, to an advertisement delivery engine. In this regard, the relevance scorer 312, or a portion thereof, is part of or is in communication with a keyword extractor, for example, that resides on one or more servers or computing devices. Although the advertisement selecting component 336 and the advertisement presenting component 338 are illustrated as part of the relevance scorer, this is not intended to limit the scope. In some embodiments, the advertisement selecting component 336 and the advertisement presenting component 338, and any other component, might reside remote from the other components. For example, the advertisement selecting component 336 and the advertisement presenting component 338 might reside within an advertisement delivery engine.

The keyword extracting component 330 is configured to extract keywords in association with web content (e.g., a webpage). The keyword extracting component 330 can use any method to extract keywords from web content, such as a webpage. By way of example only, the keyword extracting component 330 might extract each word within particular web content, words related to or pertaining to subject matter of the web content, particular types of words (e.g., nouns, verbs, etc.), words randomly selected, a word sampling including positive and negative keyword types, or the like. As can be appreciated, the web content (e.g., a webpage) from which a keyword(s) is extracted can be referenced or selected in any number of ways. For example, a webpage might be referenced or selected based on a user's indication to navigate to the particular webpage. Although illustrated as a separate component from keyword extracting component 314, the keyword extracting components could be combined into a single component or could comprise any number of components.

The relevance scoring component 332 is configured to score one or more keywords. In some embodiments, the relevance scoring component 332 scores keywords in accordance with relevance to web content, or subject matter in association therewith, using a keyword model, such as a keyword model generated by model generating component 324. The relevance scoring component 332 might, in some cases, score each extracted keyword, or a portion thereof (e.g., a random sampling, keywords near the top of the content, etc.).

In embodiments, upon referencing a keyword (e.g., receiving, retrieving, referencing, etc., an extracted keyword), the relevance scoring component 332 calculates, determines, or identifies one or more keyword features for the keyword. A keyword model can then be utilized to provide a relevance score in association with the keyword. In some cases, a relevance score might be a value between zero and one. Generally, a higher relevance score indicates a keyword that is more relevant to the web content.

By way of example only, in an online or offline operation, keyword features for a keyword are referenced, identified, determined, etc. In embodiments, a value for a feature of a keyword is calculated or recognized (e.g., a count of number of characters to get the length of a keyword, look up a query log to get the keyword's query frequency). The feature values and feature coefficients, such as predetermined feature coefficients that are stored in a data store, are substituted into the logistic function to calculate a relevance score (e.g., a positive category relevance score). Assume that the following features and coefficient values are included within a keyword model: 1) keyword length (0.018625); 2) keyword frequency (−0.0601703); 3) visual style score (0.0531785); and 4) TFIDF (0.05629). As can be appreciated, any number of features and corresponding coefficient values can exist for a keyword. In some cases, the same number of features exists for each keyword. In other cases, the number for features varies for different keywords. Further assume that the values for keyword features of the keyword “test” are: 1) keyword length (4.0); 2) keyword frequency (0.62801); 3) visual style score (0.02105); and 4) TFIDF (0.05629). In such a case, a relevance score for the keyword “test” is 0.0394198 (i.e., LF(0.018265*4.0+−0.0601703*0.62801+0.0531785*0.02105+0.291151*0.05629+−3.24605)=LF(−3.1932693)=1/(1+ê(−(−3.1932693)))=0.0394198). As previously indicated, 0.0 indicates a poor relevance keyword and 1.0 indicates a strong relevance keyword. Accordingly, the keyword “test” with a relevance score of approximately 0.039 results in a low relevance keyword and thereby is unlikely to be associated with an advertisement and displayed on a web page.

The noise filtering component 334 is configured to filter, remove, or indicate noise keywords. That is, in one embodiment, if an extracted keyword is identified as a noise keyword of a webpage or a domain in association therewith, such a keyword will be directly removed, for example, from the keyword extraction results. In another embodiment, the noise filtering component 334 might provide an indication of a noise keyword such that the advertisement selecting component 336 can utilize such information to select an advertisement. For example, the advertisement selecting component 336 might disregard any keywords that are designated as noise keywords.

The advertisement selecting component 336 is configured to select one or more advertisements for presenting to a user. Such advertisements can be displayed in association with a set of search results or a webpage. In embodiments, the advertisement selecting component 336 uses the relevance scores determined by the relevance scoring component 332 to select an advertisement(s). As the noise filtering component 334 might remove noise keywords or provide an indication of noise keywords, in such cases, the advertisement selecting component 336 does not select advertisements in association with such noise keywords. As can be appreciated, the advertisement selecting component 336 can use any number of keywords to select an advertisement(s) for display. For example, the advertisement selecting component 336 might utilize the ten keywords having the highest relevance scores to select an advertisement for display. Further, the advertisement selecting component 336 can select any number of advertisements for display. By way of example only, for a particular keyword, several advertisements might be selected for display in association with the web content.

An advertisement presenting component 338 is configured to present an advertisement in association with the advertisement context. As such, the advertisement presenting component 338 might present an advertisement in association with a search query, a search results page, a webpage, or the like. Advertisement presenting component 338 might display and/or provide audio output to present one or more advertisements.

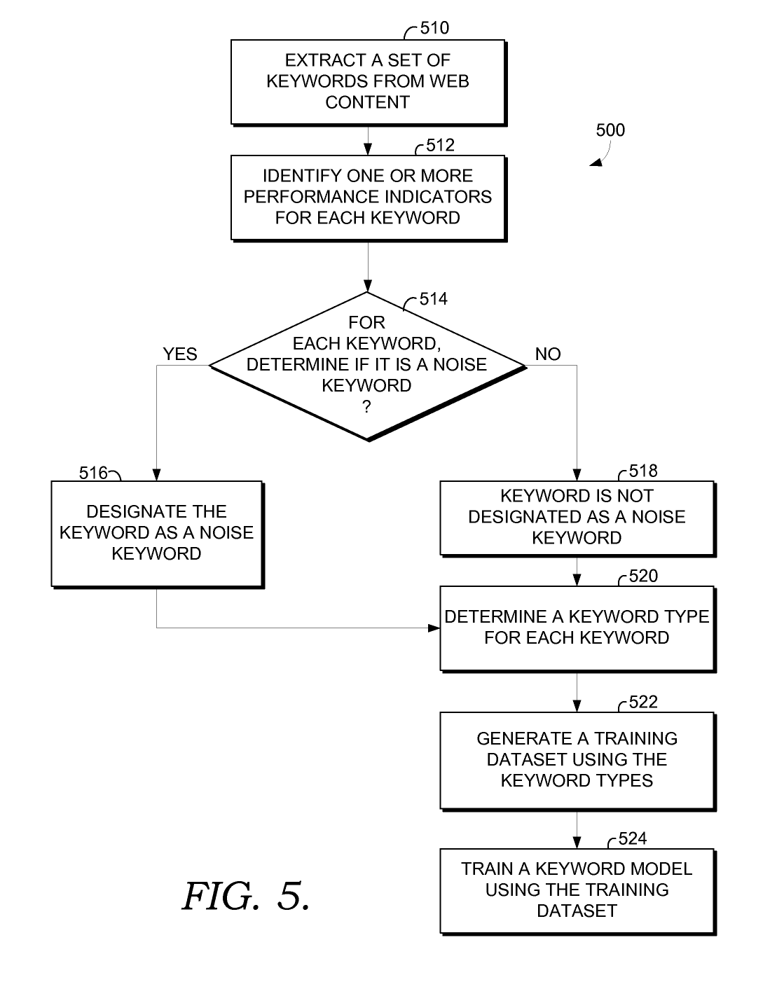

Turning now to FIG. 5, a flow diagram is illustrated which shows a first method 400 for facilitating keyword extraction for advertisement selection, in accordance with an embodiment of the present invention. Initially, at block 510, a set of keywords are extracted from web content, such as webpages in association with URLs. At block 512, for each keyword in association with a given URL, one or more performance indicators are identified. Such performance indicators may include, for example, click counts, impression counts, revenues, click-through-rates, effective cost per milles. At block 514, it is determined whether each keyword is a noise keyword using the corresponding performance indicators. In embodiments, a keyword is a noise keyword in cases that the keyword is relevant to the web content, or subject matter thereof, but generally results in a low click-through-rate and/or low effective cost per mille. If it is determined that a keyword is a noise keyword, at block 516, the keyword is designated as a noise keyword. On the other hand, it is determined that a keyword is not a noise keyword, the keyword is not designated as a noise keyword. This is indicated at block 518.

At block 520, a keyword type is determined for each keyword using the corresponding performance indicators and the designation of whether the keyword is a noise keyword. In embodiments, a keyword type can be a positive keyword, a negative keyword, and/or a profitable keyword. Subsequently, at block 522, a training dataset is generated using the keyword types for each keyword. A training dataset might include, for example, a keyword feature(s) and a keyword score(s) for each keyword. At block 524, the training dataset is used to train a keyword model. The keyword model can be used to provide a relevance score to keywords subsequently extracted.

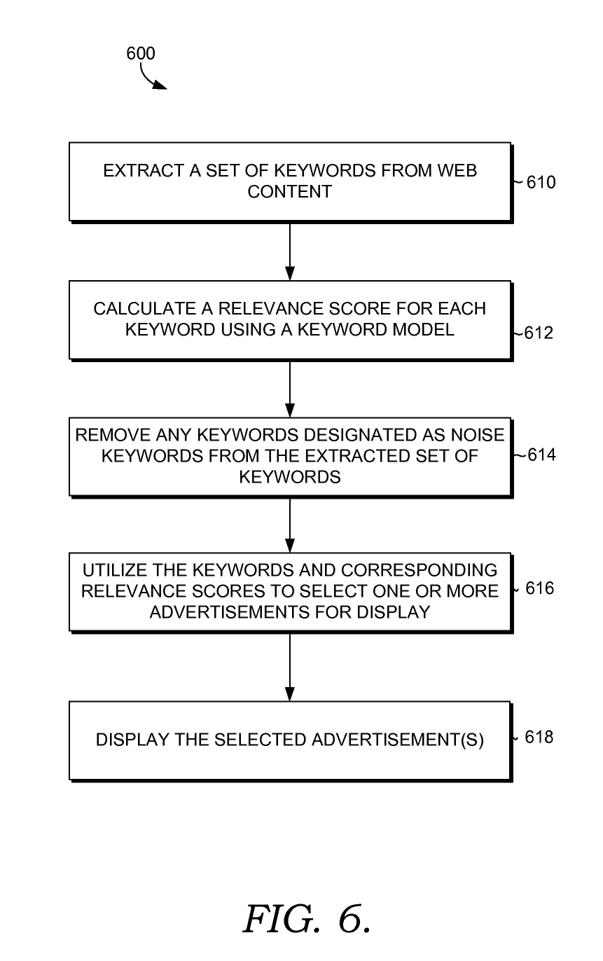

With reference to FIG. 6, a flow diagram is illustrated which shows a second method 500 for facilitating keyword extraction for advertisement selection, in accordance with an embodiment of the present invention. Initially, as indicated at block 610, a set of keywords is extracted from web content, such as a webpage in association with a URL. Subsequently, at block 612, a relevance score is calculated for each keyword using a keyword model. In embodiments, the keyword model is automatically generated (i.e., without user intervention) using performance indicators that indicate the performance of the keyword in association with one or more advertisements. By way of example only, a keyword model is generated using, at least in part, click-through-rates, click numbers, impression numbers, and effective cost per milles. At block 614, any keywords that are designated as noise keywords are removed from the set of extracted keywords or are identified as such. At block 616, the keywords and corresponding relevance scores, excluding the noise keywords, are utilized to select one or more advertisements for display. In some cases, the keyword(s) with the highest relevance scores are used to select an advertisement(s) for display. At block 618, the selected advertisement(s) are displayed, for example, in association with the webpage.

It will be understood by those of ordinary skill in the art that the order of steps shown in the method 500 of FIG. 5 and the method 600 of FIG. 6 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon, that when executed, cause a computing device to perform a method for facilitating keyword extraction for advertisement selection, the method comprising:
referencing a set of one or more performance indicators that indicate performance of a keyword in association with one or more advertisements;
determining whether the keyword is a noise keyword that is relevant to web content and results in a low click rate or a low impression cost; and
using at least a portion of the set of one or more performance indicators and the determination of whether the keyword is the noise keyword to identify a keyword type of the keyword, wherein a keyword type comprises a positive keyword or a negative keyword.

2. The media of claim 1 further comprising extracting the keyword from a webpage.

3. The media of claim 1, wherein the performance of the keyword corresponds with a particular webpage or domain.

4. The media of claim 1, wherein the set of performance indicators comprises one or more of an impression count, a click count, a revenue, a click rate, an impression cost.

5. The media of claim 1, wherein the keyword type is used to build a training dataset.

6. The media of claim 1, wherein the training dataset is used to train a keyword model to score keywords in accordance with relevance to the web content.

7. The media of claim 6 further comprising using the keyword model to score keywords subsequently extracted from the web content.

8. The media of claim 6, wherein the training dataset comprises at least one keyword feature and at least one keyword score for each keyword within the training dataset.

9. The media of claim 1, wherein the set of one or more performance indicators is used to determine whether the keyword is a noise keyword.

10. The media of claim 1 further comprising designating the keyword as a noise keyword.

11. A method for facilitating keyword extraction for advertisement selection, the method comprising:
extracting a keyword from web content;
determining that the keyword is a noise keyword using a click-through-rate and an effective cost per mille;
designating the keyword as a noise keyword; and
using the designation of the noise keyword to generate a keyword model that is used to score other keywords.

12. The method of claim 11, wherein the click-through-rate is an average click-through-rate associated with the keyword for each uniform resource locator in a domain.

13. The method of claim 11, wherein the effective cost per mille is an average effective cost per mille associated with the keyword for each uniform resource locator in a domain.

14. The method of claim 11, the noise keyword indicating a large impression number exists in association with a lower performance.

15. The method of claim 11 further comprising using the designation that the keyword is a noise keyword to determine whether the keyword is a positive keyword, a negative keyword, or a profitable keyword.

16. The method of claim 15, wherein the determination of whether the keyword is the positive keyword, the negative keyword, or the profitable keyword is used to generate a training dataset for use in generating the keyword model.

17. The method of claim 11 further comprising using the designation that the keyword is a noise keyword to prevent the keyword from being used to select an advertisement for display.

18. One or more computer storage media having computer-executable instructions embodied thereon, that when executed, cause a computing device to perform a method for facilitating keyword extraction for advertisement selection, the method comprising:
extracting a keyword from a first webpage in association with a uniform resource locator;
identifying a set of one or more performance indicators in association with the keyword;
using the set of one or more performance indicators to determine whether the keyword is a noise keyword;
identifying a keyword type of the keyword based on at least a portion of the set of one or more performance indicators and the determination of whether the keyword is the noise keyword, wherein a keyword type comprises a positive keyword, negative keyword, or profitable keyword;
using the keyword type to generate a training dataset; and
generating a keyword model in accordance with the training dataset, the keyword model being used to score keywords subsequently extracted from web content based on relevance to the web content or subject matter thereof.

19. The media of claim 19 further comprising:
extracting a set of one or more keywords from a second webpage;
using the keyword model to score the keywords; and
removing any keywords from the scored keywords that comprise a noise keyword to create a subset of keywords.

20. The media of claim 19 further comprising using the subset of one or more scored keywords to select an advertisement for display.
